(19) United States
(12) Patent Application Publication
(10) Pub. No.: US 2026/0177358 A1
(43) Pub. Date: Jun. 25, 2026

(54) BALLISTIC PROTECTIVE ARMOR AS WELL AS BALLISTIC PROTECTIVE HELMET AND PROTECTIVE VEST

(71) Applicant: Busch PROtective Germany GmbH & Co. KG, Guetersloh (DE)

(72) Inventor: Jan VAN DE SLUIS, Guetersloh (DE)

(73) Assignee: Busch PROtective Germany GmbH & Co. KG, Guetersloh (DE)

(21) Appl. No.: 19/429,098

(22) Filed: Dec. 22, 2025

(30) Foreign Application Priority Data
Dec. 23, 2024 (EP) 24 222 995.3

(51) Int. Cl. F41H 5/04; B32B 1/00; B32B 5/06

(52) U.S. Cl. CPC F41H 5/0485; B32B 1/00; B32B 5/073; B32B 2250/20; B32B 2437/04; B32B 2571/02

(57) ABSTRACT

A ballistic protective armor including: a textile laminate comprising a plurality of textile layers that are laminated together. Wherein a plurality of connectors in the form of wires or threads are provided in the textile laminate and which extend at least in part through the textile laminate in the layering direction of the textile layers, and an average areal density of connectors transversely to the layering direction, of between 180 connectors/dm² and 800 connectors/dm² is provided at least in regions of the textile laminate.

### CROSS-REFERENCE TO RELATED APPLICATION

The present application claims priority to European Patent Application No. EP 24 222 995.3, filed on Dec. 23, 2024, the entire contents of which is incorporated herein by reference.

### BACKGROUND

### Field

The present disclosure relates to a ballistic protective armor and to a corresponding ballistic protective helmet as well as to a protective vest.

### Prior Art

Ballistic protective armor of the present type is a component of ballistic protective clothing or headgear, for example military helmets, bullet-proof vests, and the like. For weight-saving reasons, such protective armor is generally manufactured from technical fabrics such as high-molecular-weight polyethylene, aramid, Kevlar, or other high-strength yarns. Individual fabric layers are laminated using an adhesive matrix in that an adhesive, a resin, or a film is applied between the individual textile layers and the entire layer package is then compressed to form a textile laminate.

The properties of the protective armor can be varied depending on the material properties of the yarns used for the textile layers, the various types of weaving, and fabric weights as well as the resin or else adhesive content in the connection matrix. Aside from the structural strength, i.e. the resistance to deformations, which is particularly important for protective helmets, the resistance to an impacting projectile or shrapnel naturally plays a prominent role. In addition to a force in the layering direction, which is referred to in the following as the Z-direction, the striking projectile also exerts forces in the directions that lie within the layer plane, i.e. in the X- and Y-direction perpendicular to the Z-direction. These forces are absorbed by the yarns or fibers of the textile layers, while the forces in the Z-direction are absorbed by the bonding of the textile layers. In other words, the adhesive strength of the matrix decisively contributes to preventing the projectile from penetrating through. The layer planes are typically curved, i.e. not planar, and therefore the X- and Y-direction are understood to be along the layer planes and are only planar in the case of planar layer planes.

It is possible to embed the textile fabric layers fully into the matrix, such that the adhesive strength of the layers to one another becomes very high. As a general rule, the forces arising during projectile impact result in stretching of the fabric fibers and energy absorption in the X- and Y-direction. This can cause bulging of the protective armor in the direction of impact. However, if a particular force or rather elongation of the fibers is exceeded, the fibers are abruptly sheared off and the projectile penetrates the corresponding layer. This shearing effect is enhanced if the fabric is fully embedded in the resin or adhesive matrix, since this restricts the possibility of the fibers to stretch longitudinally. The armor's resistance to perforation is thus reduced. Aside from this effect, a high resin or adhesive content also increases the weight of the protective armor.

Therefore, experiments have been carried out to design ballistic protective armor with less resin applied between the textile layers. This can save weight, and the energy absorption within the individual textile layers is increased, since the fabric fibers that are not embedded in the matrix can stretch unhindered. On the other hand, the grip between the layers is reduced. This has the following effect when a projectile strikes: On account of the shearing effect, the outer textile layers are pierced cleanly by the projectile, which deforms significantly in the process. The subsequent layers intercept the projectile, the kinetic energy of which is already significantly reduced at this point, on account of the stretching of the fibers within the textile layers. This causes these intercepting layers of the laminate to bulge significantly towards the inside of the protective armor, since the intercepting layers detach more easily from the perforated layers due to less resin having been applied, and delamination occurs between these layers. However, the significant bulging effect can cause serious injuries to the wearer of the ballistic protective clothing. For example, the wearer of a ballistic protective helmet that is deformed strongly inward by the impact of a projectile can sustain head injuries.

Thus, when conventional ballistic protective armor is being designed, the effect of full perforation described at the outset must be prevented, but so too must excessive deformation of the inner layers of the textile laminate. This is done by suitably coordinating the stretching properties of the textile fabric and of the resin or else adhesive component, such that the load absorption can be predefined in the different directions. However, this is only possible to a limited extent, since, firstly, the conditions during the manufacture of the protective armor are hard to reproduce and, secondly, the delamination effect occurs suddenly and almost uncontrollably when the deforming intercepting layers detach from the perforated layers. In particular, the selection of the resin or adhesive content in the connection matrix is made much more difficult by these circumstances.

WO 2005/108906 A1 discloses a ballistic protective armor, in particular as a component of ballistic protective clothing or headgear, comprising a textile laminate consisting of a plurality of textile layers that are laminated together, wherein a plurality of connectors in the form of wires or threads is provided, which extend through the textile laminate in the layering direction of the textile layers.

This has made it possible to provide ballistic protective armor that reliably prevents puncturing caused by projectiles or striking shrapnel and, at the same time, to reduce the above-described deformation effect on the inside of the protective armor opposite the exposed face, while the weight of the protective armor is kept as low as possible.

### SUMMARY

An object is to further develop the ballistic protective armor from the prior art such that the protective effect is improved while the weight of the protective armor is kept as low as possible.

Such object can be solved through a ballistic protective armor, for example, as a component of ballistic protective clothing or headgear, comprising a textile laminate consisting of a plurality of textile layers that are laminated together, wherein a plurality of connectors in the form of wires or threads are provided, which extend at least in part through the textile laminate in the layering direction of the textile layers, which ballistic protective armor is further developed in that an average areal density of connectors, such as transversely to the layering direction, of between 180 connectors/dm² and 800 connectors/dm², between 200 connectors/dm² and 700 connectors/dm², between 250 connectors/dm² and 600 connectors/dm², between 280 connectors/dm² and 500 connectors/dm², between 300 connectors/dm² and 450 connectors/dm², is provided at least in regions.

Here, “dm” means “decimeter”.

The connectors can extend completely through the textile laminate. The average areal density of connectors can be greater than is known in the prior art. A higher average areal density of connectors produces a helmet shell that is more rigid, such that the residual energy during firing is reduced. On the one hand, this can allow for a lower shell thickness of the protective armor while maintaining the same protective effect compared with the prior art or a greater protective effect of the ballistic protective armor when the same shell thickness as previously in the prior art and the same weight is used.

An average areal density of at least 180 connectors/dm², at least 200 connectors/dm², at least 250 connectors/dm², at least 280 connectors/dm², at least 300 connectors/dm², can be provided at least in regions.

An average areal density of up to 800 connectors/dm², 700 connectors/dm², 600 connectors/dm², 500 connectors/dm², 450 connectors/dm², can be provided at least in regions.

The ballistic protective armor can comprise a number of connectors in the form of wires or threads that extend through the textile laminate in the layering direction, i.e. in the direction of the surface normal perpendicular to the textile layers. These connectors can provide the individual textile layers of the laminate with additional grip between one another, in that a further mechanical connection can be created in addition to the known adhesive matrix. By selecting a suitable tensile strength or rather elasticity of the connectors, the perforation and deformation properties of the textile laminate and its resistance to a projectile impact can be improved.

The above-described bulging effect of the inner intercepting layers of the laminate that are deformed upon projectile impact can be significantly reduced, since the connectors can absorb strong tensile forces in the firing direction and can prevent the layers from being torn apart in an uncontrolled manner (delamination). Instead, the delamination effect can be restricted to the immediate surroundings of the penetration channel. In this region, the tensile forces on the connectors are so high that they tear and the inner intercepting layers can detach from one another. In the directions within the layers, i.e. in the directions perpendicular to the layering direction, the force ultimately decreases until it falls below the force required to tear the connectors, such that the connectors merely stretch. Here, the adhesive layers of the layers may detach from one another, but said layers are still stably held together by the stretched connectors. As a result, the extent of the bulging of the protective armor inward and thus the risk of injury can be significantly reduced. The kinetic projectile energy is still absorbed to a sufficient extent, and therefore the projectile cannot fully penetrate the textile laminate. The resin or adhesive content in the textile laminate can be significantly reduced without excessive deformation occurring, resulting in a weight saving and increasing wearing comfort.

The distance between the connectors in a first direction of the surface transverse to the layering direction of the textile layers can be different from a direction of said surface that is arranged transversely, such as perpendicularly, to the first direction and that is transverse to the layering direction of the textile layers. As a result, the brittleness of the ballistic protective armor can be reduced, which can reduce the tendency to piercing.

If the average areal density of connectors varies in the protective armor, regions that have specifiable ballistic effects can be defined in the ballistic protective armor.

A further solution to the object can be a ballistic protective armor, such as a component of ballistic protective clothing or headgear, comprising a textile laminate comprising a plurality of textile layers that are laminated together, wherein a plurality of connectors in the form of wires or threads are provided, which extend at least in part through the textile laminate in the layering direction of the textile layers, which ballistic protective armor is further developed in that the protective armor has an average areal density that is different in at least two regions.

If the average areal density of connectors in a central region of the protective armor is less than in an edge region of the protective armor, uniform protection against projectiles or striking shrapnel can be ensured over the entire region of the protective armor.

Protective armor, for example helmets, typically have a higher tendency to delamination at the edge than in regions close to the crown or rather in a central region of the protective armor. There is a similar amount of material in the X- and Y-direction, i.e. in the surface spanned by the protective armor or else helmet or in the surface formed by the textile layers, close to the central region of the protective armor or else the crown of a protective helmet, measured relative to the distance of the point of impact of a shot or the point of impact of a piece of shrapnel. As a result, the energy of the projectile can be distributed uniformly over a larger area in order to dissipate energy. At the edge, however, less energy is required toward the edge for delamination, and therefore the helmets or the protective armor can exhibit greater bulging toward the edge. This effect can be countered by increasing the average areal density of the connectors toward the edge. Thus, improved energy dissipation can be ensured toward the edge of the protective armor as well.

The number of textile layers in the protective armor can be different in regions. As a result, the safety of the protective armor can be optimized while keeping the weight as low as possible. If the number of textile layers in a central region of the protective armor is less than in an edge region of the protective armor, the safety aspect or rather the uniformity of the dissipation of the energy from striking projectiles or shrapnel can be adapted.

It is easier to manufacture the protective armor if the connectors are sewn into the textile layers. For example, it is possible to sew the textile layers, which are in pre-preg form, i.e. already provided with an adhesive matrix, in the wet state, such that the connectors are introduced in the wet state of the textile layers. Subsequently, the protective armor can then be compressed and cured, such that the protective armor provided with the connectors can be manufactured efficiently.

Such object can be further achieved by a ballistic protective helmet having a helmet shell that comprises a protective armor according to that described herein.

Furthermore, such object can be solved by a ballistic protective vest which comprises hard segments or hard inserts that comprise a ballistic protective armor according to that described herein.

The connectors can be provided with anchoring in the textile laminate. The connectors can be resilient. The connectors can comprise metal or a plastics material.

In a further embodiment, the connectors can be configured as reinforcing threads which can be formed in each case from a single fiber or from a number of fibers. The reinforcing threads or rather the connectors can comprise a yarn that is spun or twisted from a number of fibers.

The reinforcing threads or connectors can comprise of aramid, Kevlar, polyethylene, or carbon fibers.

The reinforcing threads or connectors can be interconnected to form continuous filaments which extend in a meandering shape through the textile laminate.

In one embodiment, continuous filaments can extend on the opposing surfaces of the textile laminate, each of which continuous filaments can comprise a number of loops that protrude into the textile laminate and that are intertwined with the loops of a continuous filament extending on the relevant opposing surface of the textile laminate.

The textile layers can be connected by compression to a connection matrix which can be arranged in layers between the individual textile layers.

In one embodiment, the connection matrix can be formed from an adhesive, a resin, or a compressible film.

Furthermore, in one embodiment, the textile layers can be embedded at least in part in the connection matrix. For example, the textile layers can comprise a plastics material. The textile layers can comprise aramid, Kevlar, polyethylene, or carbon fibers. A mixture of these materials may also be used, for example a mixture of aramid and polyethylene or aramid and carbon fibers or Kevlar with polyethylene, etc.

In one embodiment, the textile layers can comprise fabric comprising fibers or yarns. The textile layers can have different hardnesses. In one embodiment, the different hardnesses can be achieved by using different types of fabric or a different resin or adhesive content of the textile layers. In one embodiment, the textile laminate can have, viewed from the outside inward in relation to the intended firing direction, a layer sequence of hard outer textile layers, soft textile layers, the hardness of which can be less than that of the hard textile layers, and medium-hard inner textile layers, the hardness of which can be between that of the hard and soft textile layers.

In one embodiment, the connectors can be provided with a first distance from one another in a direction of the surface of the textile layers or rather of the textile laminate and with a second distance from one another in a direction transverse to said direction and in the surface of the textile layers or rather of the textile laminate. The first distance and the second distance may be different from one another.

The connectors may be sewn in a direction of the surface of the textile layers by a seam, such as using a sewing machine, wherein multiple seams can be provided one next to the other at the second distance from the stitches in the seam. The respective stitches of adjacent seams may also be arranged offset with respect to one another, such as in each case centrally with respect to two connectors of a seam.

Further features will become evident from the description of embodiments, together with the claims and the appended drawings. Embodiments can fulfill individual features or a combination of multiple features.

### BRIEF DESCRIPTION OF THE DRAWINGS

The embodiments will be described below, without restricting the general concept of the invention, based on exemplary embodiments and with reference to the drawings, wherein reference is expressly made to the drawings regarding all of the details which are not explained in greater detail in the text. In the figures:

FIG. 1 schematically illustrates a lateral partial section through a ballistic protective helmet, the helmet shell of which is formed by a ballistic protective armor;

FIG. 2 schematically illustrates a plan view of part of the helmet shell surface of the helmet from FIG. 1;

FIG. 3 schematically illustrates a partial section through a helmet shell according to another embodiment;

FIG. 4 schematically illustrates a plan view of part of the helmet shell from FIG. 3;

FIG. 5 schematically illustrates the helmet shell according to FIG. 3 in the deformed state after being struck by a projectile;

FIG. 6 schematically illustrates a partial section through a helmet shell according to a third embodiment; and

FIG. 7 schematically illustrates a plan view of part of a protective armor.

In the drawings, the same or similar elements and/or parts are, in each case, provided with the same reference signs, and therefore they are not introduced again in each case.

### DETAILED DESCRIPTION

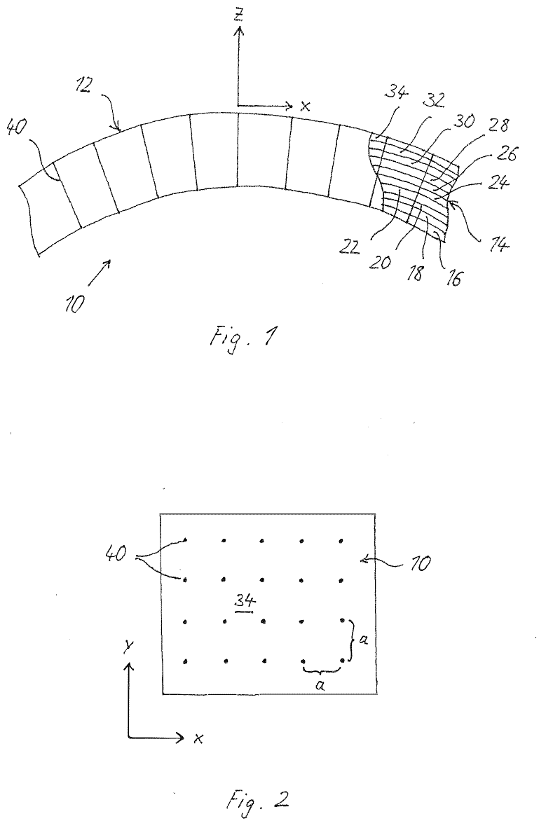

The helmet shell 10 represented in FIG. 1 is a component of a ballistic protective helmet, for example a helmet for military uses. The concave inside of the protective helmet facing the helmet wearer's head (not shown) is located at the bottom in the figure, while a projectile can strike from the convex outside. In the following, the term “projectile” is intended to include all possible ballistic projectiles, i.e. not only firearm projectiles in the narrower sense but also grenade or bullet fragments or the like.

Further inside the protective helmet, for example is a basket-shaped lining applied to the inside of the helmet shell 10, which ensures a distance between the helmet wearer's head and the inside of the helmet shell 10 and increases the wearing comfort, are not shown in this figure or in the subsequent figures.

FIG. 1 shows the helmet shell 10 in an undamaged condition. It is formed by a ballistic protective armor 12 that comprises a textile laminate 14 which is formed from a number of textile layers that are laminated together. The layers extend, following the curvature of the helmet surface, in parallel one on top of the other between the inner and outer surface of the helmet shell 10, i.e. the layering direction corresponds to the surface normal perpendicular to the surfaces of the textile layers. In FIG. 1, the layering direction is denoted by an arrow Z, which corresponds to the normal of the helmet outer surface at a particular point of curvature, while the individual textile layers extend in the X- and Y-directions perpendicular to the layering direction Z within the helmet shell 10. For the sake of completeness, the X-direction (to the right in FIG. 1) is also denoted by an arrow X.

For reasons relating to clarity, the textile layers are only shown in section in a region on the right-hand side in the figure. In reality, the layers extend through the entire helmet shell 10. In the embodiment shown here, there are ten layers 16 to 34, which are layered one on top of the other in the Z-direction. In practice, it is typical to use an even larger number of layers; however, it is within the realm of possibility for a person skilled in the art to choose a suitable number of layers. Each of the textile layers 16, . . . , 34 comprises a fabric comprising aramid, polyethylene, or carbon fibers, i.e. a plastics material having a high tensile strength in the direction X and/or Y, in which the layer extends. Furthermore, it is possible to weave the textile layers from yarns or to manufacture same using other textile techniques.

The textile layers 16, . . . , 34 are laminated together by being compressed with a connection matrix which is arranged in layers between the individual textile layers. Said connection matrix is, for example, an adhesive, a resin, or a compressible film. Thus, in order to manufacture the textile laminate 14, textile layers 16, . . . , 34 and adhesive or resin layers or else film layers are laid one on top of the other alternately and compressed under pressure, such that the textile laminate 14 is created as a composite of textile layers and connection matrix. The individual layers of the connection matrix are not shown in greater detail in FIG. 1 and the subsequent figures. The cohesion of this layer package 14, i.e. its resistance to forces in the Z-direction, which act to detach the textile layers 16, . . . , 34 from one another, as well as the weight of the helmet shell 10 can be determined by the quantity of the adhesive or resin applied or else the thickness of the compressible film between the textile layers. In principle, the strength increases with an increasing weight proportion of the connection matrix in the overall weight, and therefore the strength can be increased, for example, by applying more resin. As a result, compression of the laminate can cause the material of the connection matrix to penetrate at least in part into the fabric of the textile layers 16, . . . , 34 and the fibers of the textile layers to become embedded in the matrix. However, the ability of the fibers to stretch in the X and/or Y direction is significantly restricted by this.

The ballistic protective armor 12, which forms the helmet shell 10, comprises a number of connectors 40 in the form of wires or threads which extend through the textile laminate 14 in the layering direction Z from the inner surface of the helmet shell 10 to the outer surface, i.e. through all textile layers 16, . . . , 34. These connectors, which are spaced apart from one another in the directions X, Y, in which the textile layers 16, . . . , 34 extend, ensure additional grip between the textile layers 16, . . . , 34. In other words, the layers 16, . . . , 34 are not exclusively held together by the adhesive strength of the connection matrix, but also mechanically by the connectors 40. This increases the cohesion of the laminate 14 in the layering direction Z and, in the event of an impact by a projectile, provides advantageous properties in the event of delamination of the inner textile layers, as will be explained in more detail below.

The connectors 40, of which only the left-hand connector 40 is provided with a reference sign in FIG. 1, may consist of any suitable material that has the desired properties, i.e. such as a suitable tensile strength and elasticity. For example, a metal or a plastics material can be used for the connectors 40, and they may be flexible reinforcing threads which are formed from a single fiber or from a number of fibers which may further be spun or twisted into a yarn. High-strength materials such as aramid, polyethylene, or carbon fibers can be eligible. Although not shown in FIG. 1, it is conceivable to provide the ends of the individual connectors 40 on the outside or inside of the helmet shell 10 with anchoring such as thickened portions or the like, which prevent the connectors 40 from being easily pulled out of the layer package during delamination of the textile laminate 14.

In order for the connectors 40 to fulfill their function, it is not strictly necessary for the connectors 40 to extend precisely in the layering direction Z, or else-Z, i.e. in the direction of the surface normal of the textile layers 16, . . . , 34 at the point at which the connector 40 is pierced, but rather it is sufficient for the extension direction of the connectors 40 to have a component that corresponds to the layering direction Z, such that the textile layers 16, . . . , 34 are pierced. It is therefore permissible to enclose a particular angle with the normal. If such deviations are not desirable for design reasons, a suitable size of the deviation angle can be ascertained by a person skilled in the art without significant effort using experiments.

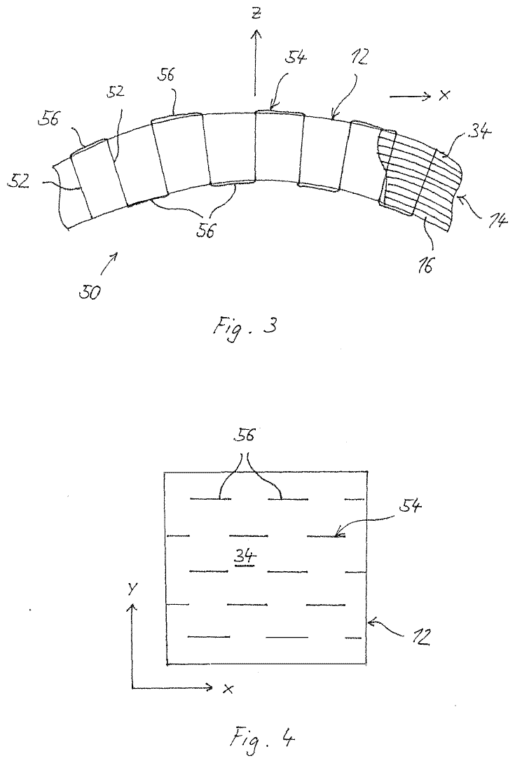

FIG. 2 shows a plan view of the helmet shell 10 with the connectors 40 inserted. Therefore, this figure merely shows part of the surface of the uppermost textile layer 34 in which the outermost ends of the connectors 40 in the form of wires or threads lie. The layering direction Z therefore points out of the drawing plane in FIG. 2. The connectors 40 are arranged in a regular square grid, i.e. the connectors 40 are arranged at the same distances a from one another in rows both in the X- and in the Y-direction, according to the extension direction of the textile layer 34. The distances a can be freely selected in order to influence the cohesion of the textile laminate 14 and the delamination behavior thereof.

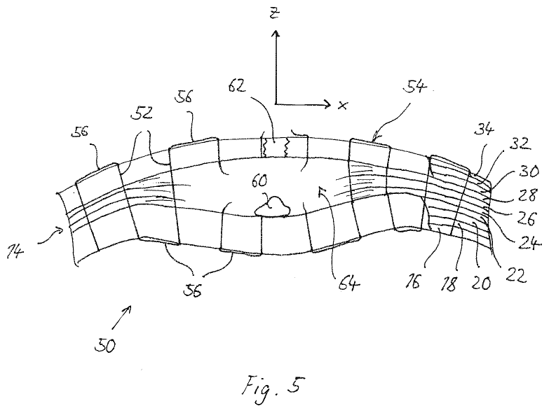

FIG. 3 shows a lateral partial section through another helmet shell 50, which is also constructed from a textile laminate 14 consisting of individual textile layers 16, . . . , 34. The structure of the individual layers 16, . . . , 34 consisting of high-strength fabric, their layering in the Z-direction, and their connection by way of layerwise compression to a connection matrix correspond to the helmet shell 10 from FIGS. 1 and 2, and therefore reference should be made to the parts of the description above with regard to the structure of the textile laminate 14.

The helmet shell 50 comprises connectors in the form of threads, which are formed here by portions 52 of a reinforcing thread 54 that extend in the layering direction Z, which reinforcing thread extends as a continuous filament between the inner and outer surface of the helmet shell 50 in a meandering shape in the direction X through the textile laminate 14, i.e. in the direction in which the textile layers 16, . . . , 34 extend. Thus, starting on the left-hand side in FIG. 3, a reinforcing thread portion 52 extending in the layering direction Z initially extends from the inside outward, and a connecting portion 56 of the reinforcing thread 54 lying on the outer surface of the helmet shell 50 follows on from said reinforcing thread portion. In turn, a reinforcing thread portion 52 that extends from the outside inward (opposite direction-Z) follows on from said connecting portion, and said reinforcing thread portion is followed by a connecting portion 56 lying on the inside of the helmet shell. This sequence of portions of the reinforcing thread 54 between the inside and outside is repeated from here continuously in the extension direction X of the textile layers 16, . . . , 34. The individual reinforcing thread portions 52 that make up the connectors are thus connected by the connecting portions 56 to form a continuous filament, which forms a seam that can extend through the entire textile laminate 14 or else helmet shell 50. The reinforcing thread 54 may be tightly tensioned so as to provide the individual textile layers 16, . . . , 34 with greater cohesion.

The reinforcing thread 54 may be a textile fiber consisting of a high-strength plastics material such as aramid, polyethylene, or carbon fiber, and multiple fibers of the reinforcing thread 54 may be spun or twisted into a yarn. In principle, the same materials can be used for the connectors 40 from the first embodiment and for the reinforcing thread 54 or rather the portions 52 thereof acting as connectors. Since, in the case of the continuous reinforcing thread 54, the course of the thread is deflected in each case at the inner and outer surfaces of the helmet shell 50, the thread material requires a certain level of pliability and flexibility.

FIG. 4 shows a plan view of part of the outermost textile layer 34 from a perspective corresponding to FIG. 2. The connecting portions 56 of the reinforcing thread 54 lying on the surface of the textile layer 16 can be seen here, while the reinforcing thread portions 52 extend into the textile laminate 14 and back out again in and counter to the layering direction (directions Z and -Z) at the ends of the connecting portions 56. In FIG. 4, the seams of the continuous filaments 54 extend from the left to the right, and the connecting portions 56 have the same length on the inside and outside of the helmet shell 50. The continuous filaments 54 are spaced apart from one another in the direction perpendicular to the course direction of the seams, and the connecting portions 56 of mutually adjacent connecting threads 54 are offset with respect to one another in the course direction of the seams in each case by the length of a connecting portion 56.

It should be understood that a different seam course can also be selected, for example by forming loops within the course of the reinforcing thread 54, as will be explained below. Furthermore, as with the above-described embodiment, it is not necessary for the reinforcing thread portions 52 to extend precisely in the direction of the surface normal, but rather deviations from this direction are tolerated. For example, successive reinforcing thread portions 52 may be inclined relative to one another in such a way that a W-shaped or zig-zag seam course is produced in the perpendicular section plane through the laminate 14.

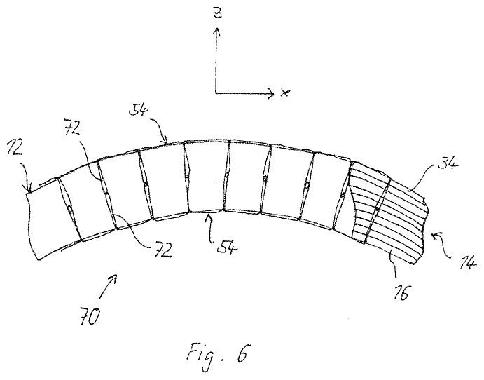

In FIG. 5, the functional principle of the ballistic protective armor is explained based on the second exemplary embodiment from FIGS. 3 and 4. In the present case, it is assumed that the helmet shell 50 is fired at with a projectile 60 that strikes exactly perpendicularly on the helmet shell 50, i.e. in the firing direction-Z. Upon impact, the projectile 60 pierces through a number of outer textile layers, wherein the fibers within the textile layers are sheared cleanly and an approximately cylindrical penetration channel 62 is formed. In the process, the projectile 60 deforms significantly, and its kinetic energy is partially absorbed until the energy is no longer sufficient to pierce through further layers. This results in a deformation in the form of inward bulging in the remaining textile layers on the inside of the helmet shell 50, since the projectile 60 stretches the fibers of the non-pierced textile layers on account of its residual energy. The projectile 60 then remains within a cavity 64 between the outer and inner textile layers. Said cavity 64 is created due to the fact that the outer pierced textile layers retain their outwardly curved shape in principle, while a detachment or delamination effect is produced by the deformation of the inner layers, whereby the outer and inner layer packages detach from one another in the surroundings of the penetration channel 62.

In FIG. 5, the three outermost textile layers 30, 32, 34 are pierced cleanly, and the penetration channel 62 is formed therein, whereas the four innermost layers 16 to 22 are bulged inward. The fabric of these textile layers 16 to 22 remains intact, and the fibers of the fabric are merely stretched, such that the bulging is formed toward the inside of the helmet shell 50. Three textile layers 24, 26, 28, which are destroyed in the immediate surroundings of the penetration channel 62 and thus absorb energy, remain between the pierced layers 30, 32, 34 and the deformed layers 16 to 22 and are referred to as the intercepting layers.

When the intercepting layers 16 to 22 tear off, the internal cohesion of the textile laminate 14 produced by the connection matrix is destroyed, and there is the risk that the layers will bulge very significantly due to them tearing off from one another in an uncontrolled manner, which would cause injuries to the helmet wearer. This disadvantageous effect is prevented by the reinforcing thread 54. The portions 52 of the reinforcing thread 54 extending in the layering direction Z can absorb the tensile forces, resulting from the impact, in the Z-direction, which causes the reinforcing thread 54 to stretch at the portions 52, and therefore additional energy is absorbed. If the forces exceed a particular value, the reinforcing thread portion 52 may tear off. Since the force decreases in the lateral direction, i.e. X- and Y-direction, in relation to the firing direction, this tear-off effect only occurs in the surroundings of the penetration channel 62, as also shown in FIG. 5. The tensile forces decrease at a greater distance from the penetration channel 62 and can still be absorbed by the reinforcing thread portions 52 without the thread 54 tearing off. This prevents the adhesive layer of the connection matrix between the pierced layers 30, 32, 34 and the intercepting layers 16 to 22 from tearing uncontrollably. The reinforcing thread portions 52 at the outer regions of the cavity 64 reliably limit the delamination effect. The absorption of the tensile forces by the reinforcing thread portions 52 is facilitated by the fact that the outer ends of the portions 52 are anchored in the outer textile layers 30, 32, 34, which retain their curved shape and thus exhibit a high stability against the tensile forces exerted by the reinforcing thread portions 52. This anchoring effect in the outer layers 30, 32, 34 provides increased support for the portions 52 and thus for the inwardly deformed region of the inner intercepting layers 16 to 22.

It should be understood that the effect of the connectors is only shown in FIG. 5 by way of example based on the reinforcing thread portions 52 and is produced to the same extent by all types of connectors within the meaning of the present disclosure, i.e. also by the connectors 40 according to the first embodiment.

The energy absorption within the textile laminate 14 can advantageously be increased by configuring the outer layers 30, 32, 34, in which the penetration channel 62 is formed, to be very hard compared to the subsequent central layers 24, 26, 28, which are destroyed in the region of the cavity 64 and thus can absorb energy. Due to the high hardness of the outer layers 30, 32, 34, the projectile 60 is deformed to a very significant extent and must form a relatively large entry channel such that it can penetrate deeper into the textile laminate 14. The hardness of the intercepting layers 16 to 22 on the inside of the helmet shell 50 is advantageously selected such that it is between the hardness of the outer layers 30, 32, 34 and that of the soft central layers 24, 26, 28, such that good deformability remains guaranteed. The hardnesses of the different layers 16, . . . , 34 can be influenced by the selection of the fabric, but also by the resin or adhesive content of the connection matrix in the textile layers 16, . . . , 34.

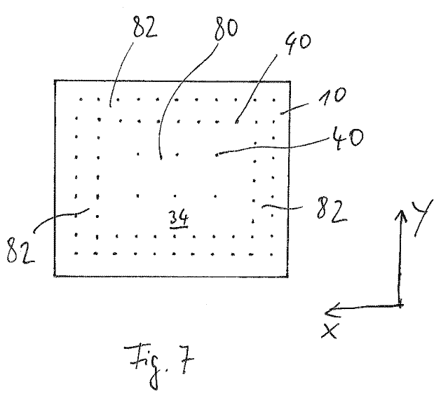

Finally, FIG. 6 shows a helmet shell 70 similar to the helmet shell 50 from FIGS. 3 to 5, in which the seams of the reinforcing threads 54 have a different course. Reinforcing threads 54 extend as continuous filaments on the opposing surfaces of the textile laminate 14, each of which continuous filaments comprises a number of loops 72 that protrude into the textile laminate 14 and that are intertwined with the loops 72 of a continuous filament extending on the relevant opposing surface of the textile laminate 14. In other words, the loops 72 of the reinforcing thread 54 lying on the outside of the helmet shell 70 point into the textile laminate 14 through a channel (not shown) counter to the layering direction Z and engage in the loops 72 of a further continuous filament 54 in the region of the central textile layers, which further continuous filament extends in the same way on the inside of the helmet. Thus, in each case two intertwined loops 72 form a connector. The loops 72 can be braced together more or less tightly, and therefore the resilient properties of the bracing can be adjusted.

A ballistic protective armor 12 of the type described here is suitable not only for helmets 10, 50 of ballistic protective helmets, but also for other types of ballistic protective clothing, for protective vests that are intended to protect the wearer from projectiles or shrapnel. Since protective vests of this kind must have a certain level of flexibility for reasons relating to wearing comfort, the known vests generally comprise hard segments or hard inserts at particularly vulnerable locations. Said hard segments or inserts can also be formed by the ballistic protective armor. In order to ensure complete protection without restricting the mobility of the vest wearer, an arrangement in which the hard segments or hard inserts overlap one another but can be pushed against one another and engage in one another is advantageous.

FIG. 7 schematically shows a plan view of a protective armor. The textile laminate is shown schematically in a plan view, as is an arrangement of connectors 40 in said textile laminate. The connectors are arranged at a first distance from one another in a direction X and at a second distance from one another in the direction Y. In the exemplary embodiment of FIG. 7, the connectors of one seam or rather in one direction are offset to the connectors of an adjacent seam or rather of an adjacent row of connectors. This arrangement allows for a very high areal density of connectors.

2.5 to 7.0 mm may be used an example for a distance between the connectors in one seam or rather in one direction and 2.5 to 7.0 mm may also be used in the other direction, wherein the distances may be the same or different.

FIG. 7 shows an edge region 82 in which the connectors are arranged so as to be offset with respect to one another and closer to one another at three edges than in a central region 80.

The embodiments make it possible to optimize the seam distance or rather the distance between the connectors for the ballistic protective armor. In the case of a large distance between the connectors, delamination occurs faster when a projectile strikes. In the case of a very close arrangement of the connectors or rather a higher areal density of connectors, delamination is reduced. However, if the areal density is too high, the projectile may penetrate through the ballistic protective armor. In this respect, the ballistic protective armor serves as an optimization.

While there has been shown and described what is considered to be preferred embodiments, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

### LIST OF REFERENCE SIGNS

10 Helmet shell
12 Protective armor
14 Textile laminate
16-34 Textile layers
40 Connector
50 Helmet shell
52 Reinforcing thread portion
54 Reinforcing thread
56 Connecting portion
60 Projectile
62 Penetration channel
64 Cavity
70 Helmet shell
72 Loop
80 Central region
82 Edge region

What is claimed is:

1. A ballistic protective armor comprising:
a textile laminate comprising a plurality of textile layers that are laminated together,
wherein a plurality of connectors in the form of wires or threads are provided in the textile laminate and which extend at least in part through the textile laminate in the layering direction of the textile layers, and
an average areal density of connectors transversely to the layering direction, of between 180 connectors/dm² and 800 connectors/dm² is provided at least in regions of the textile laminate.

2. The ballistic armor according to claim 1, wherein the average areal density of connectors is one of between 200 connectors/dm² and 700 connectors/dm², between 250 connectors/dm² and 600 connectors/dm², between 280 connectors/dm² and 500 connectors/dm², and between 300 connectors/dm² and 450 connectors/dm².

3. The ballistic protective armor according to claim 1, wherein a distance between the connectors in a first direction of the surface transverse to the layering direction of the textile layers is different from a second direction of the surface that is arranged transversely and that is transverse to the layering direction of the textile layers.

4. The ballistic protective armor according to claim 3, wherein the second direction is perpendicularly to the first direction.

5. The ballistic protective armor according to claim 1, wherein the average areal density of connectors varies in different portions of the protective armor.

6. The ballistic protective armor according to claim 5, wherein the average areal density of connectors in a central region of the protective armor is less than in an edge region of the protective armor.

7. The ballistic protective armor according to claim 1, wherein a number of textile layers varies in regions in the protective armor.

8. The ballistic protective armor according to claim 7, wherein the number of textile layers in a central region of the protective armor is less than in an edge region of the protective armor.

9. The ballistic protective armor according to claim 1, wherein the connectors are sewn into the textile layers.

10. A ballistic protective helmet having a helmet shell comprising the ballistic protective armor according to claim 1.

11. A ballistic protective vest, comprising hard segments or hard inserts comprising the ballistic protective armor according to claim 1.
